(19) United States
(12) Patent Application Publication
(10) Pub. No.: US 2023/0185973 A1
(43) Pub. Date: Jun. 15, 2023

(54) A HIGH-EFFICIENCY SIMULATION METHOD OF 3D WIND FIELD BASED ON DELAY EFFECT

(71) Applicant: DALIAN UNIVERSITY OF TECHNOLOGY, Dalian, Liaoning (CN)

(72) Inventors: Xing FU, Dalian, Liaoning (CN); Xingheng ZHANG, Dalian, Liaoning (CN); Hongnan LI, Dalian, Liaoning (CN)

(21) Appl. No.: 17/773,399

(22) PCT Filed: Jul. 19, 2021
(86) PCT No.: PCT/CN2021/106992

§ 371 Date: Apr. 29, 2022

(51) Int. Cl. G06F 30/10

(52) U.S. Cl. CPC G06F 30/10; G06F 2119/02

(57) ABSTRACT

Determining coordinates and an initial coordinate system of simulation points according to structural drawings, and transforming the coordinate system so that Y axis is parallel to the wind direction, to obtain a 3D model of N structural simulation points; projecting all the simulation points of the 3D model onto a target 2D plane, and transforming the simulation points into projection points on the 2D plane; calculating the delay time of the wind speed, that is, the time required to move from each point to the projection points on the target plane; using a 2D coherence function to consider the spatial correlation of different simulation points in horizontal and vertical directions; generating fluctuating wind speed by using harmony superposition method; and obtaining the wind speed time history of all the points by using the delay time.

### TECHNICAL FIELD

The present invention belongs to the technical field of structural wind engineering, and particularly relates to a numerical simulation method for generating wind speed time history.

### BACKGROUND

Wind disaster is one of the natural disasters that causes the greatest loss of people and property. For large structures, wind load is an important design load; and even plays a decisive role. The existing wind resistance design method mainly include wind tunnel test, numerical simulation and field measurement. Numerical simulation is an important supplement to the tunnel test. The method is convenient and repeatable, and can be used for verification and design calculation of the wind load.

The application of the wind load to the structures requires artificial synthesis of the wind speed time history with specific power spectral density and spatial correlation as excitation. In engineering, the natural wind is usually approximated as anergodicstationary Gaussian stochastic process. At present, the main wind field simulation methods include the linear filtering method, the harmony superposition method, the inverse Fourier transform method, the wavelet analysis method and other optimization methods based on this. The harmony superposition method is widely used for its rigorous theoretical derivation and simple mathematical model. The principle of the harmony superposition method is to write multivariate random samples (here referring to the wind speed time history of multiple simulation points) into the form of multinomial summation according to self-spectral density and cross spectral density. The cross spectral density matrix of the simulation points in each frequency point is subjected to Cholesky decomposition during wind speed simulation. However, as the number of large structures is increased, the number of variables in the simulation process will increase accordingly, and the dimension of the cross spectral density matrix will increase. It will become more difficult to perform Cholesky decomposition on the cross spectral density matrix, resulting in great reduction of computational efficiency. Some scholars consider introducing “Taylor's hypothesis” into the wind field simulation to replace the longitudinal spatial correlation of the wind field, and make a phase shift for the fluctuating quantity of each frequency point. This method will increase the workload during final superposition summation.

Aiming at the shortcomings of the traditional harmony superposition method in the wind field simulation, the present invention proposes an efficient simulation method of a 3D wind field based on a delay effect, namely a time delay method of wind speed. The core is to replace the longitudinal spatial correlation of the simulation points with temporal correlation according to the “Taylor's hypothesis”. The difference from the previous scholars is that 2D spatial correlation is directly used to generate fluctuating wind speed, and then the required wind speed sequence is directly extracted from the time history result as a time history result; without increasing the workload of summation.

### SUMMARY

The present invention Proposes a high-efficiency simulation method of 3D wind field based on a delay effect, namely a time delay method of wind speed, and provides an efficient calculation method for the design and safety assessment of large structures under the action of wind loads.

The technical solution of the present invention: a high-efficiency simulation method of 3D wind field based on a delay effect specifically comprises the following steps:

(1) determining coordinates and an initial coordinate system of simulation points according to structural drawings, and transforming the coordinate system so that Y axis is parallel to a wind direction, to obtain a 3D model of N structural simulation points, wherein the coordinates of the simulation points are changed from (x₁, y₁, z₁) into (x, y, z):

$$\{ \begin{matrix}x \\ y \\ z\end{matrix} \} = \{ \begin{matrix}cos θ & - sin θ & 0 \\ sin θ & cos θ & 0 \\ 0 & 0 & 1\end{matrix} \} \{ \begin{matrix}{x}_{1} \\ {y}_{1} \\ {z}_{1}\end{matrix} \} \qquad ( 1 )$$

(2) selecting y=max(y₁, y₂, . . . , y_{N}) as a target plane, where y₁, y₂, . . . , y_{N} are the coordinates of the simulation points along the wind speed direction, projecting all the simulation points of the 3D model onto the target plane, and transforming the simulation points into projection points in the target plane;

(3) according to the “Taylor's hypothesis”, considering the delay effect of wind speed and the discreteness of the wind speed during the actual simulation process, and calculating the delay time of the simulation point No. i, that is, the time required to move from the simulation points to the projection points at average wind speed:

$${t}_{s 1} ( i ) = ⌈ \frac{max ( {y}_{1} , {y}_{2} , … , {y}_{N} ) - {y}_{i}}{{V}_{m} ( {z}_{i} ) * Δ t} ⌉ * Δ t \qquad ( 2 )$$

where ┌*┐ represents rounding up to an integer, Δt is simulated time step, and Vₘ represents the average wind speed;

(4) generating fluctuating wind speed for the projection points in (2) by using harmony superposition method; using a 2D coherence function to consider the spatial correlation of different simulation points in horizontal and vertical directions; for the longitudinal correlation of simulation points, using temporal correlation of the same simulation point at different times for calculation to obtain the wind speed time history of all the points; and realizing the simulation time by time desynchronization of the fluctuating wind speed, wherein the wind speed of the point at any time t(j) is taken as:

V(xᵢ,yᵢ,zᵢ,t(j))=Vₘ(zᵢ)+Vⱼ(xᵢ,yᵢ,zᵢ,t(j)+tₛₗ(i)) (3)

in the formula, xᵢ, yᵢ, zᵢ are an abscissa, an ordinate and a vertical coordinate of the simulation points, and V_{f} represents the fluctuating wind speed.

Beneficial effects of the present invention:

(1) The dimension of the cross spectral density matrix in the simulation process is reduced, thereby improving the efficiency of the Cholesky decomposition;

(2) The time delay method of wind speed is used to simulate the longitudinal spatial correlation of fluctuating wind at different simulation points, which is simple and has strong operability.

(3) The theory of “Taylor's hypothesis” is mature, and the rationality and application scope have been widely discussed by scholars. It is reasonable to apply this hypothesis in simulation.

### DESCRIPTION OF DRAWINGS

FIG. 1 is a schematic plane view of the structural simulation points projection method of the present invention;

FIG. 2 is a structural diagram of a transmission tower-line system selected in an implementation case of the present invention, and A, B and C in the figure are target points of axial force extraction after loading;

FIG. 3 is a comparison diagram of a target simulation point axial force result in an implementation case of the present invention and a axial force time history of a traditional method.

### DETAILED DESCRIPTION

In order to make the invention purposes, features, and advantages of the present invention more obvious and understandable, the technical solutions in the embodiments of the present invention will be described clearly and completely below with reference to the drawings in the embodiments of the present invention. Obviously, the embodiments described below are only some, but not all of embodiments of the present invention. Based on the embodiments of the present invention, all other embodiments obtained by those of ordinary skill in the art without creative efforts shall fall within the protection scope of the present invention. Based on the embodiments in the present invention, all other embodiments obtained by those ordinary skilled in the art without contributing creative labor will belong to the protection scope of the present invention.

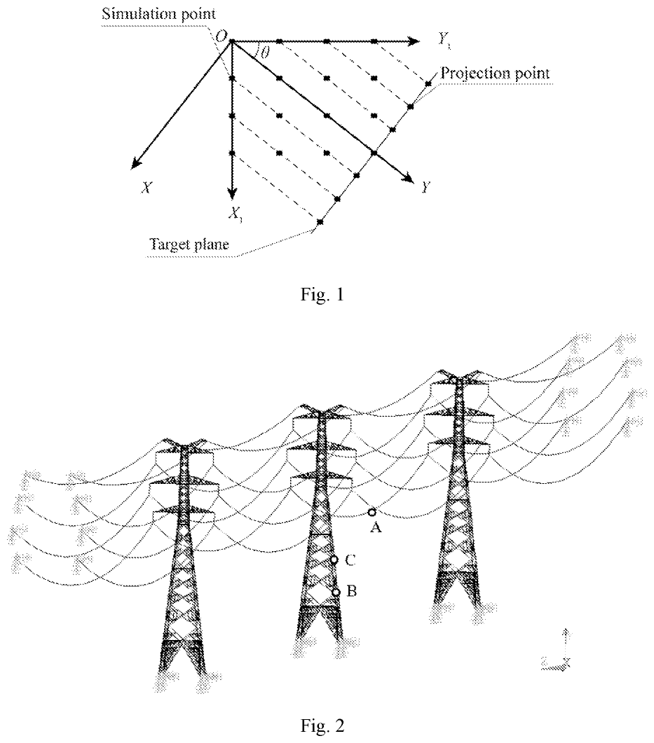

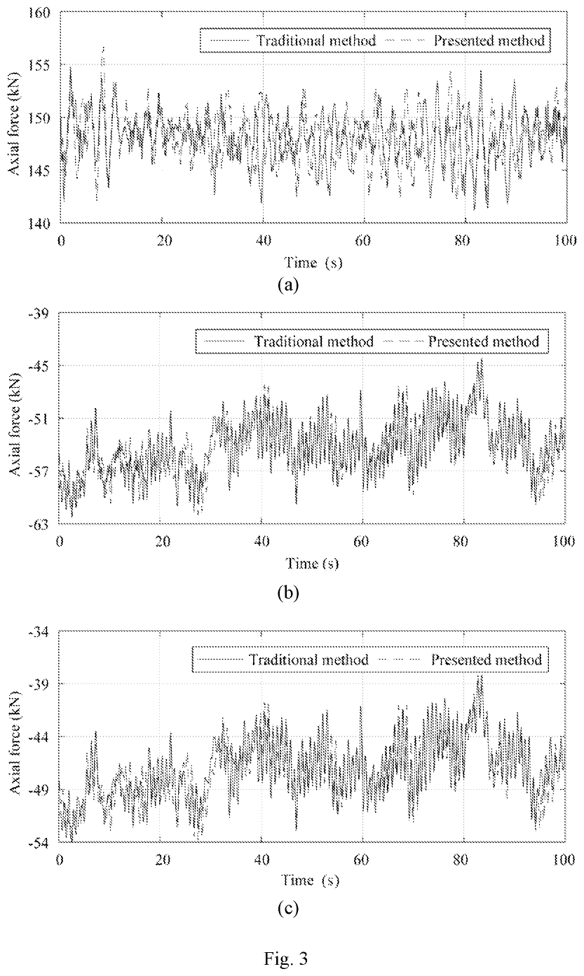

Referring to FIGS. 1-3, an embodiment of the present invention proposes a high-efficiency 3D wind field simulation method by taking a transmission tower-line system as an example.

Data source of implementation case: see “Fu X and L H N, Dynamic analysis of transmission tower-line system subjected to wind and rain loads, Journal of Wind Engineering and Industrial Aerodynamics, 2016, 157, 95-103”.

In the embodiment of the present invention, the establishment of a numerical model of a transmission tower can use self-programming or related commercial software. In the present embodiment, the widely used finite element analysis software ANSYS is used as an example to implement application of a time delay method of wind speed in applying wind loads to a transmission tower structure. In conjunction with the process shown in FIG. 1 and the technical solution of the present invention, specific illustration is as follows:

(1) The embodiment has three transmission towers with a height of 99.9 m, which are made of Q235 and Q345 equilateral angle steel, and the distance between every two towers is 500 m. The transmission towers are connected by wires. For information on tower structure and conductors, see related introduction in “Section 5” and “Section 6” of “Fu X and L H N, Dynamic analysis of transmission tower-line system subjected to wind and rain loads, Journal of Wind Engineering and Industrial Aerodynamics, 2016, 157, 95-103”. A transmission tower-line system which contains three towers and four lines finite element model is established by using ANSYS software. The ends of the conductors on both sides are in rigid connection. The BEAM188 element is selected to simulate the rods of the transmission towers. Rigid joints are used to simplify the connection between the members. An elasto-perfectly plastic model is adopted for a steel constitutive model.

(2) In the present embodiment, Davenport wind spectrum and Davenport coherence function models are used to simulate the spatial correlation of the fluctuating wind. The attenuation coefficients of the coherence function in x, y, and z directions are 16, 8 and 10 respectively, and an exponential law is used to simulate an average wind profile. The ground roughness is taken from Class B (i.e., α=0.15) of the Chinese standard “DL/T5551-2018. Load code for the design of overhead Transmission Line. National Energy Administration. 2018”, and the basic wind speed at 10 m height is 16 m/s.

(3) In the present embodiment, the traditional harmony superposition method considering 3D correlation and the time delay method of wind speed are used to generate wind loads. The time delay method of wind speed uses a 2D coherence function to consider the horizontal and longitudinal spatial correlation of different simulation points. For the spatial correlation of different longitudinal simulation points, according to the “Taylor's hypothesis”, temporal correlation of the same simulation point at different times is used for calculation to obtain the wind speed time history of all the points, and the simulation time is realized by time desynchronization of the fluctuating wind speed. The wind speed of the point at any time t can be calculated according to formula (4):

V(xᵢ,yᵢ,zᵢ,t)=Vₘ(zᵢ)+V_{f}(xᵢ,yᵢ,zᵢ,t+tₛₗ) (4)

(4) The statistical characteristics of the force at target points A, B and C of the transmission tower-line system in the two cases are extracted and compared to illustrate the rationality of the time delay method of wind speed.

When the present invention issued, it should be noted that in actual simulation, the wind speed is discretized, and the formula (4) should be converted into the following formula (3) for calculation:

$$V ( {x}_{i} , {y}_{i} , {z}_{i} , t ( j ) ) = {V}_{m} ( {z}_{i} ) + {V}_{f} ( {x}_{i} , {y}_{i} , {z}_{i} , t ( j ) + {t}_{s 1} ( i ) ) where {t}_{s 1} ( i ) = ⌈ \frac{max ( {y}_{1} , {y}_{2} , … , {y}_{N} ) - {y}_{i}}{{V}_{m} ( {z}_{i} ) * Δ t} ⌉ * Δ t ; ⌈ * ⌉ \qquad ( 3 )$$

represents rounding up to an integer; and Δt is simulated time step.

The above embodiments are only used to illustrate, but not to limit, the technical solutions of the present invention. Although the present invention has been described in detail with reference to the above embodiments, it should be understood by those ordinary skilled in the art that: the technical solutions recorded in the above embodiments can also be amended, or part of the technical features can be equivalently replaced. These amendments or replacements do not make the essence of the corresponding technical solutions deviate from the spirit and scope of the technical solutions of the embodiments of the present invention.

1. A high-efficiency simulation method of 3D wind field based on a delay effect, comprising the following steps:
(1) determining coordinates and an initial coordinate system of simulation points according to structural drawings, and transforming the coordinate system so that Y axis is parallel to a wind direction, to obtain a 3D model of N structural simulation points; selecting a plane perpendicular to y=max(y₁, y₂, . . . , y_{N}) as a target plane, where y₁, y₂, . . . , y_{N} are the coordinates of the simulation points along the wind speed direction; projecting all the simulation points of the 3D model onto the target plane; and transforming the simulation points into projection points on a 2D plane;
(2) according to the “Taylor's hypothesis”, considering the delay effect of wind speed and the discreteness of the wind speed during the actual simulation process, and calculating the delay time of the simulation point No. i, that is, the time required to move from the simulation points to the projection points at average wind speed:
$${t}_{s 1} ( i ) = ⌈ \frac{max ( {y}_{1} , {y}_{2} , … , {y}_{N} ) - {y}_{i}}{{V}_{m} ( {z}_{i} ) * Δ t} ⌉ * Δ t \qquad ( 2 )$$
where ┌*┐ represents rounding up to an integer, Δt is simulated time step, and Vₘ represents the average wind speed;
(3) generating fluctuating wind speed for the projection points in step (1) by using harmony superposition method; using a 2D coherence function to consider the spatial correlation of different simulation points in horizontal and vertical directions; for the longitudinal correlation of simulation points, using temporal correlation of the same simulation point at different times for calculation to obtain the wind speed time history of all the points; and generating the time history by time desynchronization of the fluctuating wind speed, wherein the wind speed of the point at any time t(f) is taken as:
V(xᵢ,yᵢ,zᵢ,t(j))=Vₘ(zᵢ)+V_{f}(xᵢ,yᵢ,zᵢ,t(j)+tₛₗ(i)) (1)
in the formula, xᵢ, yᵢ, zᵢ are an abscissa, an ordinate and a vertical coordinate of the simulation points, and V_{f} represents the fluctuating wind speed.
